(19) United States
(12) Patent Application Publication
(10) Pub. No.: US 2018/0322516 A1
(43) Pub. Date: Nov. 8, 2018

(54) QUALITY EVALUATION METHOD, APPARATUS AND DEVICE, AND COMPUTER READABLE STORAGE MEDIUM

(71) Applicant: BEIJING BAIDU NETCOM SCIENCE AND TECHNOLOGY CO., LTD., Beijing (CN)

(72) Inventors: Xiaomin FANG, Beijing (CN); Zeheng WU, Beijing (CN); Fan WANG, Beijing (CN); Jingzhou HE, Beijing (CN)

(21) Appl. No.: 15/934,463

(22) Filed: Mar. 23, 2018

(30) Foreign Application Priority Data
May 8, 2017 (CN) 201710317023.9

(51) Int. Cl. G06Q 30/02; G06F 15/18; G06N 3/02

(52) U.S. Cl. CPC G06Q 30/0202; G06N 3/02; G06F 15/18; G06Q 30/0201

(57) ABSTRACT

Embodiments of the present disclosure provide a quality evaluation method, apparatus and device, and a computer readable storage medium. The method includes: obtaining basic information of a target object before a preset time point; dividing the basic information to obtain a relation combination of divisible attributes and leaf attributes, in which, any one of the divisible attribute may be served as a parent node of another divisible attribute and/or a leaf attribute; and performing a quality evaluation according to the relation combination to obtain an evaluation result.

### CROSS REFERENCE TO RELATED APPLICATION

This application is based upon and claims priority to Chinese Patent Application Serial No. 201710317023.9, filed with the Status Intellectual Property Office of P. R. China on May 8, 2017, the entire contents of which are incorporated herein by reference.

### FIELD

The present disclosure relates to quality evaluation technologies, and more particularly, to a quality evaluation method, apparatus and device, and a computer readable storage medium.

### BACKGROUND

At present, with the continuous improvement of economic level, China's film and television industry is also developing rapidly, and the competition in the film and television industry is gradually increasing. Box office of a film or the audience and clicking rating of a TV series is an important index to measure the quality of film or television work. Therefore, it is particularly important to predict the box office of the film and the audience and clicking rating of the TV series.

In the related art, there are generally two ways to predict the box office of the film, one is to predict the box office through advance ticket sales and film row piece rate when the film is about to be shown, and the other is to predict total box office of the film through single-day box office or total box office of a week during the exhibition of the film. Since the box office is predicted during the exhibition of the film or when the film is about to be shown, the prediction has very limited influence on making operation decisions, determining film row piece and pricing for advertisements.

### SUMMARY

Embodiments of the present disclosure provide a quality evaluation method, apparatus and device, and a computer readable storage medium.

According to a first aspect, embodiments of the present disclosure provide a quality evaluation method. The method includes: obtaining basic information of a target object before a preset time point; dividing the basic information to obtain a relation combination of divisible attributes and leaf attributes, in which, any one of the divisible attributes can be served as a parent node of another divisible attribute and/or a leaf attribute; and performing a quality evaluation according to the relation combination to obtain an evaluation result.

According to a second aspect, embodiments of the present disclosure provide a quality evaluation apparatus. The apparatus includes: a basic information obtaining module, configured to obtain basic information of a target object before a preset time point; a basic information dividing module, configured to divide the basic information to obtain a relation combination of divisible attributes and leaf attributes, in which, any one of the divisible attributes can be served as a parent node of another divisible attribute and/or a leaf attribute; and a quality evaluation module, configured to perform a quality evaluation according to the relation combination to obtain an evaluation result.

According to a third aspect, embodiments of the present disclosure provide a quality evaluation device. The device includes one or more processors and a storage device configured to store one or more programs. When the one or more programs are executed by the one or more processors, the one or more processors are caused to perform the quality evaluation method according to the first aspect of the present disclosure.

According to a fourth aspect, embodiments of the present disclosure provide a computer readable storage medium having computer programs stored thereon. When the computer programs are executed by a processor, the quality evaluation method according to the first aspect of the present disclosure is performed.

### BRIEF DESCRIPTION OF THE DRAWINGS

FIG. 1 is a flow chart of a quality evaluation method according to a first embodiment of the present disclosure;

FIG. 2 is a schematic diagram of a relation combination of attributes obtained after dividing film information according to the first embodiment of the present disclosure;

FIG. 3 is a flow chart of a quality evaluation method according to a second embodiment of the present disclosure;

FIG. 4 is a block diagram of a quality evaluation apparatus according to a third embodiment of the present disclosure; and

FIG. 5 is a block diagram of a quality evaluation device according to a fourth embodiment of the present disclosure.

### DETAILED DESCRIPTION

The present disclosure will be described in detail below with reference to the accompanying drawings and the embodiments. It should be understood that, the specific embodiments described herein are only used to explain the present disclosure rather than to limit the present disclosure. In addition, it should also be noted that, for convenience of description, only part but not all structures related to the present disclosure are illustrated in the accompanying drawings.

### First Embodiment

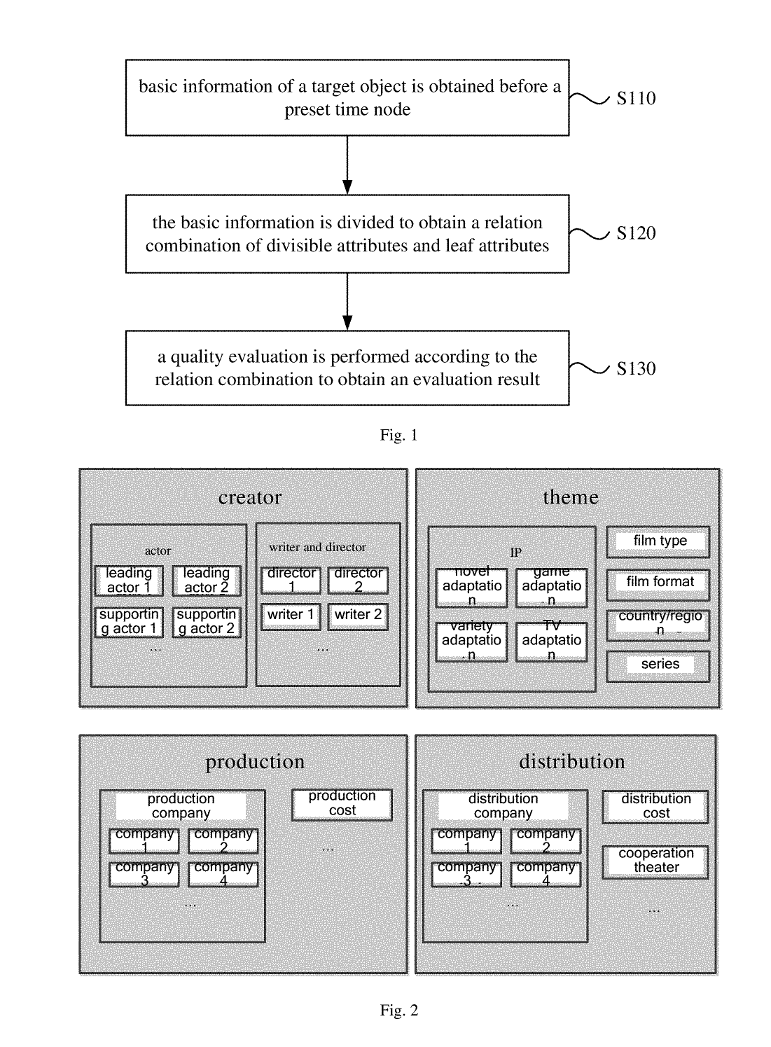

FIG. 1 is a flow chart of a quality evaluation method according to the first embodiment of the present disclosure. The present embodiment may be applicable to a case of performing quality evaluation on a target object. As illustrated in FIG. 1, the method includes followings.

At lock S110, basic information of a target object is obtained (at a time) before a preset time node.

The target object can be a film, a TV series, a record or a real estate. A time before the preset time point may be any time before the target object is released. For example, when the target object is the film, the TV series or the record, the time before the preset time point may include a production stage of the target object. When the target object is the real estate, the time before the preset time point may include a construction phase of the real estate. The basic information may be information that represents different attributes of the target object and affects the quality of the target object. For example, the basic information of the film and the TV series may include creators, theme, production and distribution, etc. The basic information of the record may include creators, production and distribution, etc. The basic information of the real estate may include developers, construction companies and geographical environment, etc.

The basic information of the target object can be obtained by performing multi-angle and all-around analysis on the target object, listing various factors that affect the quality of the target object, and summarizing the basic information of the target object.

At block S120, the basic information is divided to obtain a relation combination of divisible attributes and leaf attributes. Any one of the divisible attributes may be served as a parent node of another divisible attribute and/or a leaf attribute.

The divisible attribute may be an attribute that can be further divided into a divisible attribute and/or a leaf attribute. The leaf attribute may be an attribute that cannot be divided and can only be represented by its feature parameters. The basic information may be divided according to a logical inclusion relationship of attributes of the basic information, to obtain the relation combination of the divisible attributes and the leaf attributes. Exemplarily, taking the film as an example, FIG. 2 is a schematic diagram of a relation combination of attributes obtained after dividing film information according to the first embodiment of the present disclosure. As illustrated in FIG. 2, the basic information of the film includes “creator”, “theme”, “production” and “distribution”, and “creator”, “theme”, “production” and “distribution” belong to divisible attributes of the basic information of the film. The attribute “creator” includes “actor” and “editor”, and “actor” and “editor” belong to divisible attributes, in which, the attribute “actor” includes leaf attributes such as “leading actor 1”, “leading actor 2”, “supporting actor 1” and “supporting actor 2”, etc. The attribute “theme” includes “intellectual property (IP)”, “film type”, “film format”, “country/region” and “series”, in which, “IP” is the divisible attribute, and “film type”, “film format”, “country/region” and “series” are leaf attributes, i.e., the attribute “theme” is the parent node of “IP”, “film type”, “film format”, “country/region” and “series”.

At block S130, a quality evaluation is performed according to the relation combination to obtain an evaluation result.

In an application scenario, performing the quality evaluation according to the relation combination to obtain the evaluation result may include performing the quality evaluation on the target object according to the relation combination to obtain an evaluation parameter, and predicting an operation result according to the evaluation parameter. The evaluation parameter can be expressed by percentage, for example, the evaluation parameter obtained by performing the quality evaluation on the attribute “actor” in the basic information of the film is 80%. Predicting the operation result according to the evaluation parameter may include analyzing the evaluation parameter in combination with objective factors to obtain the operation result. Exemplarily, taking the film as an example, after the quality evaluation is performed on each attribute in the film to obtain the evaluation parameter, it is necessary to perform an analysis in combination with situations of other films of the same type which are shown during the exhibition of the film, to predict final total box office of the film, and then determine the film row piece, price for advertisements and make the operation decisions according to the predicted total box office. When the target object is the real estate, after the quality evaluation is performed on each attribute in the real estate to obtain the evaluation parameter, it is necessary to predict a total revenue of the real estate in combination with current market conditions and relevant government policies, and determine selling price and selling batch of the real estate according to the predicted total revenue.

In at least one embodiment, performing the quality evaluation according to the relation combination to obtain the evaluation result may include: traversing the divisible attributes and the leaf attributes, to obtain a type of the attribute traversed currently, when the type of the attribute traversed currently is a leaf attribute, performing the quality evaluation on the leaf attribute according to feature parameters of the leaf attribute, to obtain an evaluation parameter of the leaf attribute; and when the type of the attribute traversed currently is a divisible attribute, obtaining an evaluation parameter of a child node of the divisible attribute, and determining an evaluation parameter of the divisible attribute according to the evaluation parameter of the child node.

In at least one embodiment, performing the quality evaluation according to the relation combination to obtain the evaluation result may include performing the quality evaluation on the relation combination based on a preset machine learning model and/or a preset evaluation function, to obtain the evaluation result. The preset machine learning model includes at least one of a logistic regression model, a gradient boosting decision tree model, and a neural network model. The preset evaluation function can be a linear weighted sum function. For example, when the quality evaluation is performed on a divisible attribute of the target object by using the preset evaluation function, a calculation formula may be expressed as Y=f (y1, y2, . . . , yn; a)=a1*y1+a2*y2+ . . . +an*yn. Y represents the evaluation parameter of the divisible attribute. y1, y2 yn represent evaluation parameters of the child nodes included in the divisible attribute. a represents a weight vector, which can be expressed as a=[a1, a2, . . . an]. The weight of each child node can be set manually, or can be trained through the learning model. Performing the quality evaluation on a divisible attribute of the target object by using the preset machine learning model may include inputting the evaluation parameters of all the child nodes included in the divisible attribute into the preset machine learning model, and obtaining the evaluation parameter of the divisible attribute by learning and training of the model.

With the technical solutions provided by embodiments of the present disclosure, the basic information of the target object is obtained before the preset time point, then the basic information is divided to obtain the relation combination of divisible attributes and leaf attributes, and finally the quality evaluation is performed according to the relation combination to obtain the evaluation result. In the related art, when evaluating the quality, only some attributes of the target object are evaluated, such that the evaluation result is relatively one-sided. In embodiments of the present disclosure, the basic information of the target object is divided into the relation combination of the divisible attributes and the leaf attributes, and the quality evaluation is performed according to the relation combination of the divisible attributes and the leaf attributes, i.e., the basic information of the target object is divided from several dimensions, and attributes of each dimension are evaluated, so that the evaluation result is more accurate, thus improving the reliability of quality evaluation. In the embodiment, quality of the target object is evaluated through the basic information of the target object, and the basic information is fixed and reliable, so that the evaluation result is more reliable, and since the basic information can be obtained during a production stage of the target object, evaluation results can be obtained earlier. Especially for the film and television industry, it takes 1-2 years for a film from production to exhibition. If the evaluation result of the film can be obtained during the production stage, it will be of great reference value for making operation decisions, determining film row piece and pricing for advertisements.

### Second Embodiment

FIG. 3 is a flow chart of a quality evaluation method according to the second embodiment of the present disclosure. On the basis of the above embodiments, as illustrated in FIG. 3, performing the quality evaluation according to the relation combination to obtain the evaluation result may be implemented as follows.

At block S131, the divisible attributes and the leaf attributes are traversed, to obtain a type of the attribute traversed currently.

In an application scenario, after the basic information of the target object is divided, and the relation combination of the divisible attributes and the leaf attributes are obtained, the relation combination of the divisible attributes and the leaf attributes needs to be traversed, to perform the quality evaluation on each attribute. When the obtained divisible attributes and the leaf attributes are traversed, if an attribute has no child node, the attribute is configured as a leaf attribute, and if an attribute still includes a child node, the attribute is configured as a divisible attribute.

At block S132, when the type of the attribute traversed currently is a leaf attribute, the quality evaluation is performed on the leaf attribute according to feature parameters of the leaf attribute, to obtain an evaluation parameter of the leaf attribute.

When the obtained relation combination of the divisible attributes and the leaf attributes is traversed, when the type of the attribute traversed currently is a leaf attribute, the feature parameters of the leaf attribute are obtained first, and then the quality evaluation is performed on the leaf attribute according to the feature parameters of the leaf attribute and based on the preset machine learning model and/or the preset evaluation function. Exemplarily, taking the leaf attribute “leading actor 1” in the film as an example, feature parameters of “leading actor 1” include box office and public praise A1 of a previous film, the number of fans A2, the number of micro-blog topics A3, the number of post bar topics A4 and the number of news A5. When the quality of “leading actor 1” is evaluated based on the preset evaluation function, the calculation formula can be expressed as A=f(A1, A2, A3, A4, A5; x)=x1*A1+x2*A2+x3*A3+x4*A4+x5*A5. A is the evaluation parameter of “leading actor 1”. x is a weight vector of the feature parameters, which can be represented as x=[x1, x2, x3, x4, x5]. The weight of each feature can be set manually, or can be trained through the learning model. For example, for each feature parameter of “leading actor 1”, an evaluator considers that the box office and public praise A1 of a previous film and the number of micro-blog topics A3 are more important, and then weights of these two feature parameters may be set larger. Evaluating the quality of “leading actor 1” based on the preset machine learning model may include inputting the feature parameters of “leading actor 1” such as the box office and public praise A1 of a previous film, the number of fans A2, the number of micro-blog topics A3, the number of post bar topics A4 and the number of news A5 into the preset machine learning model, and obtaining the evaluation parameter of “leading actor 1” by learning and training of the model.

At block S133, when the type of the attribute traversed currently is a divisible attribute, an evaluation parameter of a child node of the divisible attribute is obtained, and an evaluation parameter of the divisible attribute is determined according to the evaluation parameter of the child node.

When the obtained relation combination of the divisible attributes and the leaf attributes is traversed, when the type of the attribute traversed currently is a divisible attribute, the evaluation parameter of the child node of the divisible attribute is obtained first. When the child node is a leaf attribute, the way of obtaining the evaluation parameter of this child node is the same as that of S132. When the child node is a divisible attribute, then the evaluation parameter of a child node of this child node needs to be obtained. After evaluation parameters of all the child nodes of the divisible attribute are obtained, the evaluation parameter of the divisible attribute is determined according to the evaluation parameters of the child nodes and based on the preset machine learning model and/or the preset evaluation function. Exemplarily, taking a attribute “distribution” in the divisible attributes in the film as an example, the child nodes of the attribute “distribution” include an attribute “distribution company”, an attribute “distribution cost”, and an attribute “cooperation theater”, and evaluation parameters of the child nodes are respectively B1 for the attribute “distribution company”, B2 for the attribute “distribution cost” and B3 for the attribute “cooperation theater”. The way of performing the quality evaluation on the attribute “distribution” based on the preset machine learning model and/or the preset evaluation function is the same as that for the leaf attribute “leading actor 1” at block S132, which are not described herein again.

Similarly, when performing overall quality evaluation on the target object, it is necessary to obtain the evaluation parameter of the child node included in the basic information, and perform the overall quality evaluation on the target object according to the evaluation parameter and based on the preset machine learning model and/or the preset evaluation function. Exemplarily, the basic information of the film includes four divisible attributes such as “creator”, “theme”, “production” and “distribution”, then the evaluation parameters of the four divisible attributes need to be obtained respectively, and the overall quality evaluation is performed on the target object.

With the technical solutions provided by embodiments of the present disclosure, the obtained divisible attributes and the leaf attributes are traversed, to obtain the type of the attribute traversed currently, when the type of the attribute traversed currently is the leaf attribute, the quality evaluation is performed on the leaf attribute according to feature parameters of the leaf attribute, to obtain the evaluation parameter of the leaf attribute, and when the type of the attribute traversed currently is the divisible attribute, the evaluation parameter of the child node of the divisible attribute is obtained, and the evaluation parameter of the divisible attribute is determined according to the evaluation parameter of the child node. By performing the quality evaluation on attributes of each dimension in the basic information, the quality evaluation result of the target object can be obtained comprehensively.

### Third Embodiment

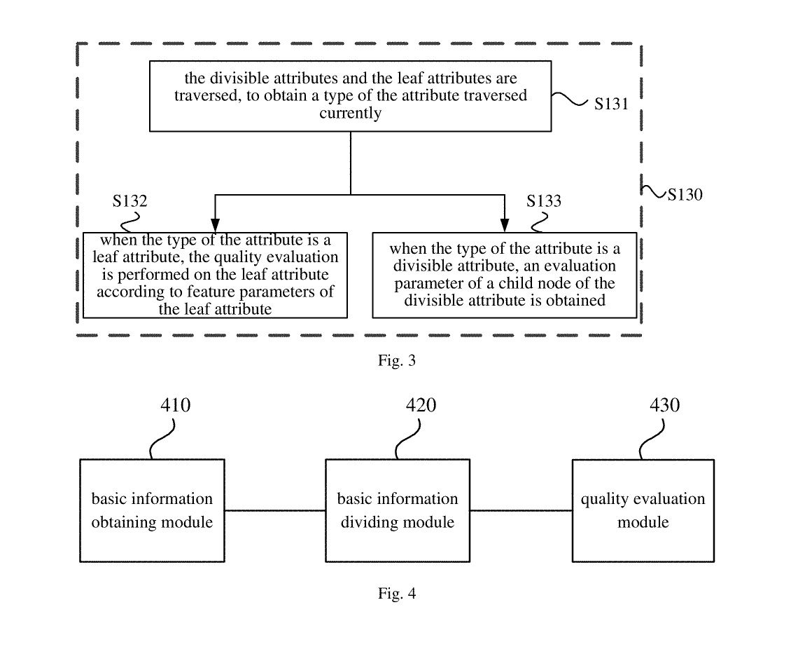

FIG. 4 is a block diagram of a quality evaluation apparatus according to the third embodiment of the present disclosure. As illustrated in FIG. 4, the apparatus includes a basic information obtaining module 410, a basic information dividing module 420 and a quality evaluation module 430.

The basic information obtaining module 410 is configured to obtain basic information of a target object before a preset time point.

The basic information dividing module 420 is configured to divide the basic information to obtain a relation combination of divisible attributes and leaf attributes, in which, any one of the divisible attributes may be served as a parent node of another divisible attribute and/or a leaf attribute.

The quality evaluation module 430 is configured to perform a quality evaluation according to the relation combination to obtain an evaluation result.

In at least one embodiment, the quality evaluation module 430 is further configured to traverse the divisible attributes and the leaf attributes, to obtain a type of the attribute traversed currently; when the type of the attribute traversed currently is the leaf attribute, perform the quality evaluation on the leaf attribute according to feature parameters of the leaf attribute, to obtain an evaluation parameter of the leaf attribute; and when the type of the attribute traversed currently is the divisible attribute, obtain an evaluation parameter of a child node of the divisible attribute, and determine an evaluation parameter of the divisible attribute according to the evaluation parameter of the child node.

In at least one embodiment, the quality evaluation module 430 is further configured to perform the quality evaluation on the target object according to the relation combination, to obtain an evaluation parameter; and predict an operation result according to the evaluation parameter.

In at least one embodiment, the quality evaluation module 430 is further configured to perform the quality evaluation on the relation combination based on a preset machine learning model and/or a preset evaluation function, to obtain the evaluation result.

### Fourth Embodiment

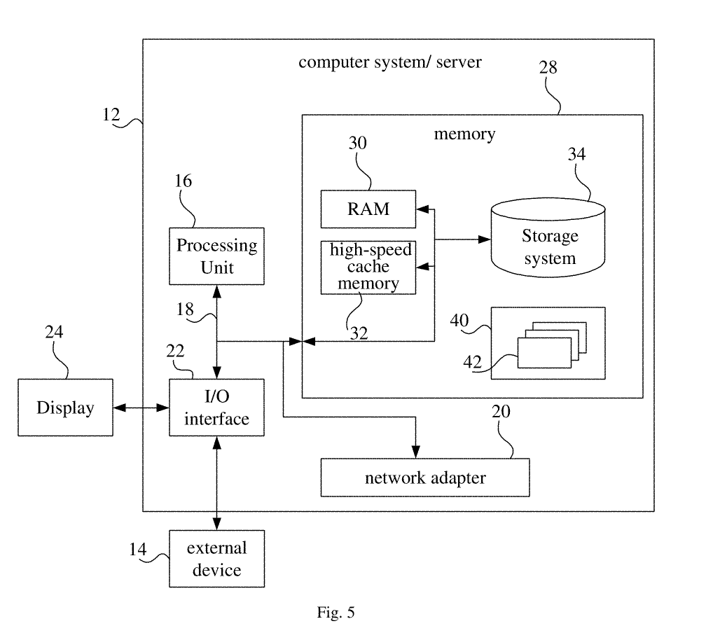

FIG. 5 is block diagram of a quality evaluating device according to the fourth embodiment of the present disclosure. FIG. 5 is a block diagram of an example device 12 for implementing embodiments of the present disclosure. The device 12 illustrated in FIG. 5 is only illustrated as an example, and should not be considered as any restriction on the function and the usage range of embodiments of the present disclosure.

As illustrated in FIG. 5, the device 12 is in the form of a general-purpose computing apparatus. The device 12 may include, but is not limited to, one or more processors or processing units 16, a system memory 28, and a bus 18 connecting different system components (including the system memory 28 and the processing unit 16).

The bus 18 represents one or more of any of several types of bus architectures, including a memory bus or a memory controller, a peripheral bus, an accelerated graphic port, a processor, or a local bus using any bus architecture in a variety of bus architectures. For example, these architectures include, but are not limited to, an industry standard architecture (ISA) bus, a micro-channel architecture (MCA) bus, an enhanced ISA bus, a video electronic standards association (VESA) local bus, and a peripheral component interconnect (PCI) bus.

Typically, the device 12 may include a variety of computer-readable media. These media may be any available media accessible by the device 12, including volatile and non-volatile media, removable and non-removable media.

The system memory 28 may include a computer system readable medium in a form of volatile memory, such as a random access memory (RAM) 30 and/or a high-speed cache memory 32. The device 12 may further include other removable or non-removable, volatile or non-volatile computer system storage media. By way of example only, the storage system 34 may be used to read and write non-removable, non-volatile magnetic media (not shown in FIG. 5, commonly referred to as “hard drive”). Although not illustrated in FIG. 5, it may be provided a magnetic disk driver for reading from and writing to a removable and non-volatile magnetic disk (e.g. “floppy disk”), as well as an optical driver for reading from and writing to a removable and non-volatile optical disk (e.g. a compact disc read only memory (CD-ROM), a digital video disc read only Memory (DVD-ROM), or other optical media). In these cases, each driver may be connected to the bus 18 via one or more data medium interfaces. The memory 28 may include at least one program product, which has a set of (for example at least one) program modules configured to perform the functions of various embodiments of the present disclosure.

A program/application 40 with a set of (at least one) program modules 42 may be stored in the memory 28, the program modules 42 include, but are not limit to, an operating system, one or more application programs, other program modules and program data. Each of these examples, or some combination thereof, may include an implementation in a network environment. The program modules 42 are generally configured to implement functions and/or methods described in embodiments of the present disclosure.

The device 12 may also communicate with one or more external devices 14 (e.g., a keyboard, a pointing device, a display 24, and etc.) and may also communicate with one or more devices enabling a user to interact with the device 12, and/or any device (e.g., a network card, a modem, and etc.) enabling the device 12 to communicate with one or more other computing devices. This kind of communication can be achieved by the input/output (I/O) interface 22. In addition, the device 12 may communicate with one or more networks such as a local area network (LAN), a wide area network (WAN) and/or a public network such as the Internet through a network adapter 20. As shown in FIG. 5, the network adapter 20 communicates with other modules of the device 12 over the bus 18. It should be understood that although not shown in FIG. 5, other hardware and/or software modules may be used in conjunction with the device 12, which include, but are not limited to, microcode, device drivers, redundant processing units, external disk drive arrays, RAID systems, tape drives, as well as data backup storage systems and the like.

The processing unit 16 can perform various functional applications and data processing by running programs stored in the system memory 28, for example, to perform the quality evaluation method provided by embodiments of the present disclosure.

### Fifth Embodiment

The fifth Embodiment of the present disclosure provides a computer readable storage medium.

The computer readable storage medium provided by embodiments of the present disclosure may adopt any combination of one or more computer readable medium(s). The computer readable medium may be a computer readable signal medium or a computer readable storage medium. The computer readable storage medium may be, but is not limited to, for example, an electrical, magnetic, optical, electromagnetic, infrared, or semiconductor system, apparatus, device, component or any combination thereof. More specific examples (a non-exhaustive list) of the computer readable storage medium include: an electrical connection having one or more wires, a portable computer disk, a hard disk, a random access memory (RAM), a read only memory (ROM), an Erasable Programmable Read Only Memory (EPROM) or a flash memory, an optical fiber, a compact disc read-only memory (CD-ROM), an optical memory component, a magnetic memory component, or any suitable combination thereof. In context, the computer readable storage medium may be any tangible medium including or storing programs. The programs may be used by or in connection with an instruction executed system, apparatus or device.

The computer readable signal medium may include a data signal propagating in baseband or as part of a carrier wave, which carries computer readable program codes. Such propagated data signal may take any of a variety of forms, including but not limited to an electromagnetic signal, an optical signal, or any suitable combination thereof. The computer readable signal medium may also be any computer readable medium other than the computer readable storage medium, which may send, propagate, or transport programs used by or in connection with an instruction executed system, apparatus or device.

The program code stored on the computer readable medium may be transmitted using any appropriate medium, including but not limited to wireless, wireline, optical fiber cable, RF, or any suitable combination thereof.

The computer program code for carrying out operations of embodiments of the present disclosure may be written in one or more programming languages. The programming language includes an object oriented programming language, such as Java, Smalltalk, C++, as well as conventional procedural programming language, such as “C” language or similar programming language. The program code may be executed entirely on a user's computer, partly on the user's computer, as a separate software package, partly on the user's computer, partly on a remote computer, or entirely on the remote computer or server. In a case of the remote computer, the remote computer may be connected to the user's computer or an external computer (such as using an Internet service provider to connect over the Internet) through any kind of network, including a Local Area Network (hereafter referred as to LAN) or a Wide Area Network (hereafter referred as to WAN).

The above device may perform the method provided by all the foregoing embodiments of the present disclosure, includes corresponding functional modules configured to perform the above method and has beneficial effects. For technical details not described in detail in this embodiment, reference may be made to the method provided in all the foregoing embodiments of the present disclosure.

It should be noted that, the above are only preferred embodiments and applied technical principles of the present disclosure. Those skilled in the art should understand that, the present disclosure is not limited to the specific embodiments described herein, and various obvious changes, readjustments and substitutions that are made by those skilled in the art will not depart from the scope of the present disclosure. Therefore, although the present disclosure has been described in detail by the above embodiments, the present disclosure is not limited to the above embodiments, and more other equivalent embodiments may be included without departing from the concept of the present disclosure, and the scope of the present disclosure is determined by the scope of the appended claims.

What is claimed is:

1. A quality evaluation method, comprising:
obtaining basic information of a target object before a preset time point;
dividing the basic information to obtain a relation combination of divisible attributes and leaf attributes, wherein, any one of the divisible attributes can be served as a parent node of at least one of another divisible attribute and a leaf attribute; and
performing a quality evaluation according to the relation combination to obtain an evaluation result.

2. The quality evaluation method according to claim 1, wherein, performing the quality evaluation according to the relation combination to obtain the evaluation result comprises:
traversing the divisible attributes and the leaf attributes, to obtain a type of the attribute traversed currently;
when the type of the attribute traversed currently is the leaf attribute, performing the quality evaluation on the leaf attribute according to feature parameters of the leaf attribute, to obtain an evaluation parameter of the leaf attribute; and
when the type of the attribute traversed currently is the divisible attribute, obtaining an evaluation parameter of a child node of the divisible attribute, and determining an evaluation parameter of the divisible attribute according to the evaluation parameter of the child node.

3. The quality evaluation method according to claim 1, wherein, performing the quality evaluation according to the relation combination to obtain the evaluation result comprises:
performing the quality evaluation on the target object according to the relation combination to obtain an evaluation parameter; and
predicting an operation result according to the evaluation parameter.

4. The quality evaluation method according to claim 1, wherein, performing the quality evaluation according to the relation combination to obtain the evaluation result comprises:
performing the quality evaluation on the relation combination based on at least one of a preset machine learning model and a preset evaluation function, to obtain the evaluation result.

5. The quality evaluation method according to claim 4, wherein, the preset machine learning model comprises at least one of following machine learning models: a logistic regression model, a gradient boosting decision tree model, and a neural network model.

6. The quality evaluation method according to claim 1, wherein, obtaining basic information of a target object comprises:
performing multi-angle and all-around analysis on the target object;
listing various factors that affect the quality of the target object;
and summarizing the basic information of the target object according to the various factors.

7. The quality evaluation method according to claim 2, wherein, performing the quality evaluation on the leaf attribute according to feature parameters of the leaf attribute comprises:
inputting the feature parameters of the leaf attribute into a preset machine learning model; and
obtaining the evaluation parameter of the leaf attribute by learning and training of the preset machine learning model.

8. The quality evaluation method according to claim 2, wherein, determining an evaluation parameter of the divisible attribute according to the evaluation parameter of the child node comprises:
inputting evaluation parameters of all child nodes included in the divisible attribute into a preset machine learning model; and
obtaining the evaluation parameter of the divisible attribute by learning and training of the preset machine learning model.

9. A quality evaluation device comprising:
one or more processors; and
a storage device configured to store one or more programs,
wherein when the one or more programs are executed by the one or more processors, the one or more processors are caused to perform the quality evaluation method, comprising:
obtaining basic information of a target object before a preset time point;
dividing the basic information to obtain a relation combination of divisible attributes and leaf attributes, wherein, any one of the divisible attributes can be served as a parent node of at least one of another divisible attribute and a leaf attribute; and
performing a quality evaluation according to the relation combination to obtain an evaluation result.

10. The quality evaluation device according to claim 9, wherein, performing the quality evaluation according to the relation combination to obtain the evaluation result comprises:
traversing the divisible attributes and the leaf attributes, to obtain a type of the attribute traversed currently;
when the type of the attribute traversed currently is the leaf attribute, performing the quality evaluation on the leaf attribute according to feature parameters of the leaf attribute, to obtain an evaluation parameter of the leaf attribute; and
when the type of the attribute traversed currently is the divisible attribute, obtaining an evaluation parameter of a child node of the divisible attribute, and determining an evaluation parameter of the divisible attribute according to the evaluation parameter of the child node.

11. The quality evaluation device according to claim 9, wherein, performing the quality evaluation according to the relation combination to obtain the evaluation result comprises:
performing the quality evaluation on the target object according to the relation combination to obtain an evaluation parameter; and
predicting an operation result according to the evaluation parameter.

12. The quality evaluation device according to claim 9, wherein, performing the quality evaluation according to the relation combination to obtain the evaluation result comprises:
performing the quality evaluation on the relation combination based on at least one of a preset machine learning model and a preset evaluation function, to obtain the evaluation result.

13. The quality evaluation device according to claim 12, wherein, the preset machine learning model comprises at least one of following machine learning models: a logistic regression model, a gradient boosting decision tree model, and a neural network model.

14. The quality evaluation device according to claim 9, wherein, obtaining basic information of a target object comprises:
performing multi-angle and all-around analysis on the target object;
listing various factors that affect the quality of the target object;
and summarizing the basic information of the target object according to the various factors.

15. The quality evaluation device according to claim 10, wherein, performing the quality evaluation on the leaf attribute according to feature parameters of the leaf attribute comprises:
inputting the feature parameters of the leaf attribute into a preset machine learning model; and
obtaining the evaluation parameter of the leaf attribute by learning and training of the preset machine learning model.

16. The quality evaluation method according to claim 10, wherein, determining an evaluation parameter of the divisible attribute according to the evaluation parameter of the child node comprises:
inputting evaluation parameters of all child nodes included in the divisible attribute into a preset machine learning model; and
obtaining the evaluation parameter of the divisible attribute by learning and training of the preset machine learning model.

17. A computer readable storage medium, stored thereon with computer programs that, when executed by a processor, perform the quality evaluation method, comprising:
obtaining basic information of a target object before a preset time point;
dividing the basic information to obtain a relation combination of divisible attributes and leaf attributes, wherein, any one of the divisible attributes can be served as a parent node of at least one of another divisible attribute and a leaf attribute; and
performing a quality evaluation according to the relation combination to obtain an evaluation result.

18. The computer readable storage medium according to claim 17, wherein, performing the quality evaluation according to the relation combination to obtain the evaluation result comprises:
traversing the divisible attributes and the leaf attributes, to obtain a type of the attribute traversed currently;
when the type of the attribute traversed currently is the leaf attribute, performing the quality evaluation on the leaf attribute according to feature parameters of the leaf attribute, to obtain an evaluation parameter of the leaf attribute; and
when the type of the attribute traversed currently is the divisible attribute, obtaining an evaluation parameter of a child node of the divisible attribute, and determining an evaluation parameter of the divisible attribute according to the evaluation parameter of the child node.

19. The computer readable storage medium according to claim 17, wherein, performing the quality evaluation according to the relation combination to obtain the evaluation result comprises:
performing the quality evaluation on the target object according to the relation combination to obtain an evaluation parameter; and
predicting an operation result according to the evaluation parameter.

20. The computer readable storage medium according to claim 17, wherein, performing the quality evaluation according to the relation combination to obtain the evaluation result comprises:
performing the quality evaluation on the relation combination based on at least one of a preset machine learning model and a preset evaluation function, to obtain the evaluation result.
